(19) United States
(12) Patent Application Publication
(10) Pub. No.: US 2005/0159985 A1
(43) Pub. Date: Jul. 21, 2005

(54) System and method of stratifying intervention groups and comparison groups based on disease severity index scores and ranges

(76) Inventor: Carl T. Bertram, Downers Grove, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/994,560

(22) Filed: Nov. 22, 2004

Related U.S. Application Data
(60) Provisional application No. 60/524,174, filed on Nov. 21, 2003.

(51) Int. Cl. G06F 17/60

(52) U.S. Cl. 705/3

(57) ABSTRACT

A method of intervention by retail pharmacies prevents adverse health outcomes resulting from drug-drug and/or drug-disease interactions, in turn, reducing medical payouts for healthcare insurers. Methods of intervention and for measuring the impact of such intervention are provided herein. The methods of measuring the impact of intervention comprise comparing intervention groups against control groups using comparison methodology. The comparison methodology described herein includes categorizing patients using the disease severity index.

### RELATED APPLICATION

This patent claims priority from U.S. Provisional Application Ser. No. 60/524,174 which was filed on Nov. 21, 2003 and is expressly incorporated by reference herein.

### TECHNICAL FIELD

The present disclosure relates generally to a system for monitoring potential drug interactions, intervening to prevent adverse health outcomes, and measuring the impact of such intervention.

### BACKGROUND

Drug-drug interactions occur in patients taking multiple prescription drugs and are the result of one drug interacting with or interfering with another drug, thereby resulting in, for example, decreased efficacy, toxicity, etc. Drug-disease interactions result when a medication intended for treatment of one disease is in conflict with the treatment of a different disease in the same patient. Avoiding drug interactions increases the safety and efficacy of prescription drugs.

Complex scenarios of drug interactions result when patients take multiple prescriptions prescribed by multiple doctors. Oftentimes, elderly patients see multiple doctors for multiple illnesses. In turn, due in large part to a lack of communication between patients and their doctors, doctors treating one illness are unaware of medications being taken by individual patients for treatment of other illnesses. In turn, patients take multiple prescription drugs prescribed by multiple doctors, thereby increasing the chance of adverse drug interactions. The complexity of these situations is compounded where patients disregard instructions and take medications irregularly and haphazardly.

Understanding drug interactions is important both to the general health of patients taking prescription drugs and to the healthcare insurers of these patients. Specifically, in 2002, $140 billion was spent on prescription drugs, while $177 billion was spent on treating adverse health outcomes of prescription drugs, including side effects or drug interactions.

Many tools are available for screening for adverse drug interactions and for notifying physicians and/or patients about the same, including pharmacists, pharmacy technicians, administrative personnel, computer hardware, computer software, and clinical algorithms. Currently, some pharmacies are attempting to combat the adverse health outcomes caused by drug interactions by reviewing customer or patient files for prescriptions filled at individual stores, and identifying patients who are at risk for adverse health outcomes due to particular drug combinations or drug-disease combinations. While this effort is admirable, a need remains for a system that identifies potentially harmful drug interactions in patients taking prescription medications prescribed by various doctors. Further, a system is needed that identifies harmful drug interactions, even where customers purchase the interacting medications from multiple pharmacies. In addition, there remains a need for an efficient system of notifying doctors of potentially harmful drug interactions, thereby preventing the intake by patients of conflicting drugs and avoiding adverse health outcomes. Such intervention systems comprise a service sold to healthcare providers, i.e., insurance companies, managed care plans, employers, and state Medicaid departments, and function to lower overall medical care payouts. However, in order for a retail pharmacy to sell such a service to healthcare insurers, it may be necessary to demonstrate credible, accurate clinical and financial returns on the investment or cost of such a service.

### BRIEF DESCRIPTION OF THE DRAWINGS

FIG. 1 is a block diagram of an embodiment of an intelligent network system.

FIG. 2 is a block diagram of an alternative embodiment of an intelligent network system that includes a separate prescription drug manager.

FIG. 3 is a block diagram of an alternative embodiment of an intelligent network system that includes a patient or customer device.

FIG. 4 is a schematic diagram of some of the components of the network computer shown in FIGS. 1, 2, and 3.

FIG. 5 is a schematic diagram of an embodiment of one of the stores shown schematically in FIGS. 1, 2, and 3.

FIGS. 6A, 6B, and 6C are three parts of a flowchart showing some of the steps for providing an intervention service to patients of healthcare insurers and measuring the impact thereof using comparison methodology and the disease severity index.

### DETAILED DESCRIPTION OF VARIOUS EMBODIMENTS

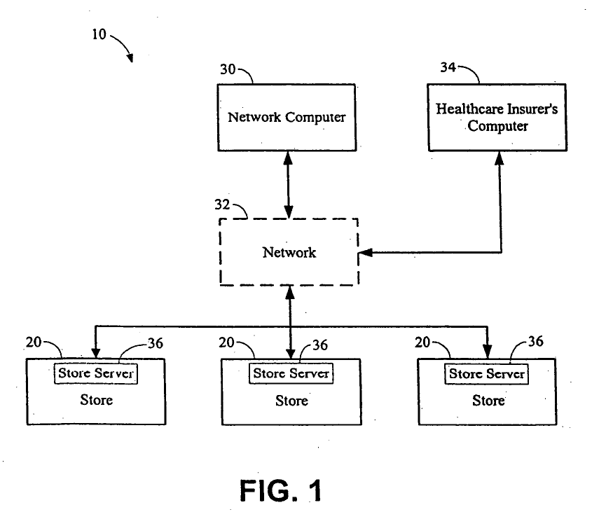

FIG. 1 illustrates an embodiment of a data network 10. Referring to FIG. 1, the data network 10 may include a first group of stores or facilities 20 operatively coupled to a network computer (i.e., a machine) 30 via a network 32. The plurality of stores 20 may be located, by way of example rather than limitation, in separate geographic locations from each other, in different areas of the same city, or in different states. The network computer 30 may be connected to an employer's or an insurer's computer 34, for example, via the network 32. The employer or insurer, referred to hereinafter as a “healthcare insurer,” may be, by way of example rather than limitation, a Managed Care Organization, an HMO, state Medicaid departments, a general insurer, employers of various sizes, or an aggregation of different sizes, so long as there exists a population of individuals (hereinafter referred to as “patients”), whose medical expenses are, to some extent, covered by the healthcare insurer. The network 32 may be provided using a wide variety of techniques well known to those skilled in the art for the transfer of electronic data. For example, the network 32 may comprise dedicated access lines, plain, ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to the operation of the stores 20 and more particularly to prescriptions filled at the stores. For example, the network computer 30 may periodically receive data from each of the stores 20 pertaining to prescriptions filled by the individual patients of the healthcare insurers. The network computer 30 may also receive information from the healthcare insurer 34 related to medical claims of the healthcare insurer's patients. The medical claim data for each individual patient may be combined with the patient's prescription data as compiled from various stores 20 to create a complete medical and prescription file for each patient covered by the healthcare insurer. In addition to the prescription data complied from the stores 20, the patient's file may be supplemented with data pertaining to prescriptions filled outside of the stores 20 via the medical claim data provided by the healthcare insurer. The totality of this information, i.e., the patient's file, may be periodically transferred to and from the network computer 30 and the healthcare insurer's computer 34 via the network 32. Further, the patients' files may be updated with additional data over the same network and computers. The stores 20 may include one or more store servers 36 that may be utilized to store patients' information, including prescriptions filled by patients covered under one or more healthcare insurers.

Although the data network 10 is shown to include one network computer 30, one healthcare insurer's computer 34, and three stores 20, it should be understood that different numbers of computers and stores may be utilized. For example, the network 32 may include a plurality of network computers 30, a plurality of healthcare insurers' computers 34, and hundreds or thousands of stores 20, all of which may be interconnected via the network 32. According to the disclosed example, this configuration may provide several advantages, such as, for example, enabling near real time uploads and downloads of information, as well as periodic uploads and downloads of information. This provides for a primary backup of all the information generated in transactions where prescriptions are filled.

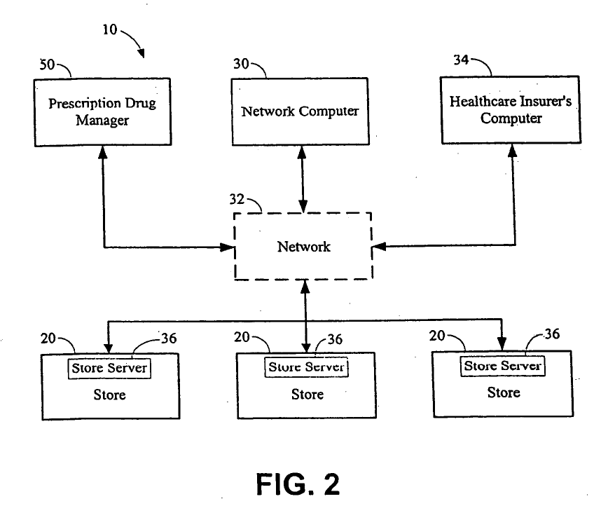

FIG. 2 illustrates an alternative embodiment of the network 10 shown in FIG. 1, wherein a prescription drug manager 50 is used to manage- and monitor the prescription drugs being taken by patients of the healthcare insurers. The embodiment of FIG. 2 is similar to the embodiment shown in FIG. 1 and includes many of the same structures and components. For clarity, the structures and components remaining the same are shown with like reference numbers as those from FIG. 1. Referring to FIG. 2, a prescription drug manager 50 may be linked to the network 32 so that data may be transferred between the prescription drug manager 50 and the network computer 30, the stores 20, and the healthcare insurer 34.

The prescription drug manager 50 may be used as a repository to store prescription drug and medical claim data of patients. In addition to storing patients' prescription drug and medical claim data, the prescription drug manager 50 may also be used to analyze the accumulated data, and screen for adverse drug interactions or other adverse health outcomes as evinced by particular combinations of drugs or illnesses. The prescription drug manager 50 may be an unrelated third party vendor, or it may be a subsidiary or division of the retailer.

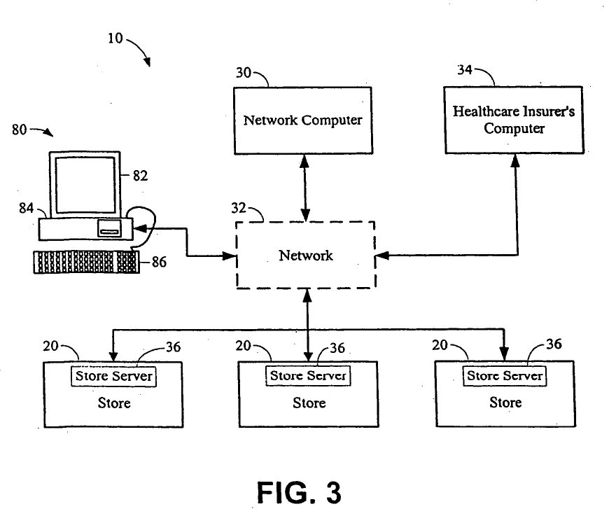

FIG. 3 illustrates another alternative embodiment of the network 10 shown in FIG. 1, wherein a customer device 80 is linked to the network 32 to enable a customer/patient to submit prescriptions or update their file using the customer device 80. The embodiment of FIG. 3 is similar to the embodiment shown in FIGS. 1 and 2 and includes many of the same structures and components. For clarity, the structures and components remaining the same are shown with like reference numbers as those from FIGS. 1 and 2.

Referring to FIG. 3, the customer device 80 may include a display 82, a controller 84, a keyboard 86, as well as a variety of other input/output devices (not shown). The customer device 80 may be linked to the network 32 so that a patient, a subscriber, or someone associated with the patient or subscriber may submit or order prescriptions from the retailer without having to physically visit one of the stores 20. In addition, the patient may wish to update his/her file by informing the pharmacist of other relevant information, e.g., over-the-counter medications, laboratory test results, family history, etc. The healthcare insurer 34 may still have access to the patient's file, even though the patient submitted the prescription via the customer device 80. The retailer may provide the patient the option of having the prescription shipped to the patient or having the prescription made available at a local retail store 20 for pickup by the patient.

While the network 10 is shown to include one network computer 30, one healthcare insurer 34, three stores 20, and one customer device 80, it should be understood that different numbers of computers, stores, and customer devices may be utilized. For example, the network 32 may include a plurality of network computers 30, a plurality of healthcare insurer 34, hundreds or thousands of stores 20, and a plurality of customer devices 80, all of which may be interconnected via the network 32.

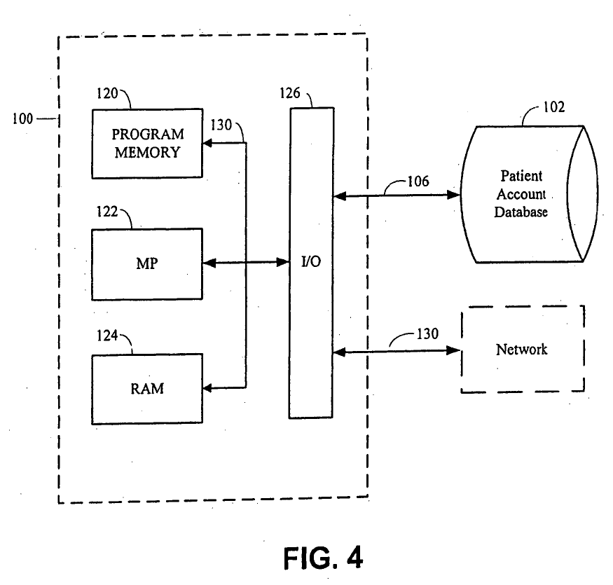

FIG. 4 is a schematic diagram of one possible embodiment of the network computer 30 shown in FIGS. 1, 2, and 3. The network computer 30 may have a controller 100 that is operatively connected to a patient account database 102 via a link 106. It should be noted that, while not shown, additional databases may be linked to the controller 100 in a known manner.

The controller 100 may include a program memory 120, a microcontroller or a microprocessor (MP) 122, a random-access memory (RAM) 124, and an input/output (I/O) circuit 126, all of which may be interconnected via an address/data bus 130. It should be appreciated that although only one microprocessor 122 is shown, the controller 100 may include multiple microprocessors 122. Similarly, the memory of the controller 100 may include multiple RAMs 124 and multiple program memories 120. Although the I/O circuit 126 is shown as a single block, it should be appreciated that the I/O circuit 126 may include a number of different types of I/O circuits. The RAM(s) 124 and programs memories 120 may be implemented as semiconductor memories, magnetically readable memories, and/or optically readable memories, for example. The controller 100 may also be operatively connected to the network 32 via a link 130.

For the purpose of this description, a machine-accessible medium includes any mechanism that provides (i.e., stores and/or transmits) information in a form accessible by a machine (e.g., a computer, network device, personal digital assistant, manufacturing tool, any device with a set of one or more processors). For example, a machine-accessible medium includes recordable/non-recordable media (e.g., read only memory (ROM); random access memory (RAM); magnetic disk storage media; optical storage media; flash memory devices), as well as electrical, optical, acoustical, or other form of propagated signals (e.g., carrier waves, infrared signals, digital signals), etc.

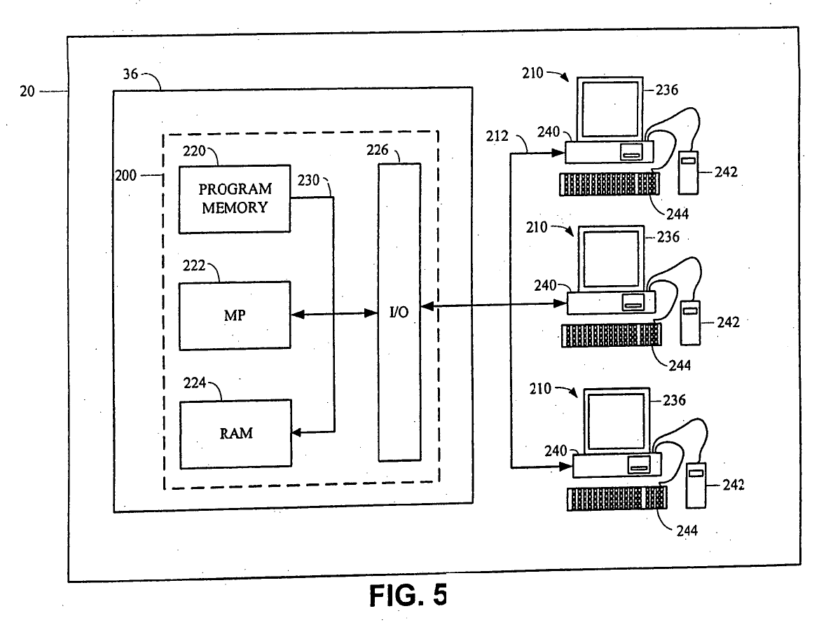

FIG. 5 is a schematic diagram of one possible embodiment of several components located in one or more of the stores 20 from FIGS. 1, 2, and 3. Although the following description addresses the design of the stores 20, it should be understood that the design of one or more of the stores 20 may be different from the design of other stores 20. Also, each store 20 may have various different structures and methods of operation. It should also be understood that the embodiment shown in FIG. 5 illustrates some of the components and data connections present in a pharmacy section of a retail store, however it does not illustrate all of the data connections present in a typical store (i.e., a photo department, a cosmetic department, a plurality of front line terminals, etc.). For exemplary purposes, various designs of the stores are described below, but it should be understood that numerous other designs may be utilized.

The store 20 may have a store server 36, which includes a controller 200, wherein the store server 36 is operatively connected to a plurality of point-of-sale (POS) terminals 210 via a network 212. The network 212 may be a wide area network (WAN), a local area network (LAN), or any other type of network readily known to those persons skilled in the art. The POS terminals 210 may also be operatively connected to the network computer 30 from FIGS. 1, 2, and 3 via the network 32.

Similar to the controller 100 from FIG. 4, the controller 200 may include a program memory 220, a microcontroller or a microprocessor (MP) 222, a random-access memory (RAM) 224, and an input/output (I/O) circuit 226, all of which may be interconnected via an address/data bus 230. As discussed with reference to the controller 100, it should be appreciated that although only one microprocessor 222 is shown, the controller 200 may include multiple microprocessors 222. Similarly, the memory of the controller 200 may include multiple RAMs 224 and multiple programs memories 220. Although the I/O circuit 226 is shown as a single block, the I/O circuit 226 may include a number of different types of I/O circuits. The RAM(s) 224 and programs memories 220 may also be implemented as semiconductor memories, magnetically readable memories, and/or optically readable memories, for example.

The POS terminals 210 may include a display 236, a controller 240, a printer 242, a keyboard 244, as well as a variety of other input/output devices (not shown) such as a mouse, touch screen, track pad, track ball, isopoint, voice recognition system, etc. Each POS terminal 210 may be signed onto and occupied by a store employee or pharmacist to assist them in performing their duties. Store employees may sign onto a POS terminal 210 using any generically available technique, such as entering a user name and password. If a store employee is required to sign onto a POS terminal 210, this information may be passed via the link 212 to the store server 36, so that the controller 200 will be able to identify which store employees are signed onto the system and which POS terminal 210 the employees are signed onto. This may be useful in monitoring the store employees' sales performance and pharmacists' general performance.

Typically, store servers 36 store a plurality of files, programs, and other data for use by the POS terminals 210 and the network computer 30. One store server 36 may handle requests for prescription data from a large number of POS terminals 210. Accordingly, each store server 36 may typically comprise a high end computer with a large storage capacity, one or more fast microprocessors, and one or more high speed network connections. Conversely, relative to a typical store server 36, each POS terminal 210 may typically include less storage capacity, a single microprocessor, and a single network connection.

### Overall Operation of the System

One manner in which an exemplary system may operate is described below in connection with a flow chart, which represents a number of portions or routines of one or more computer programs. These computer program portions may be stored in one or more of the memories in the controllers 100 and 200, and may be written at any high level language such as C, C++, or the like, or any low-level assembly or machine language. By storing the computer program portions therein, various portions of the memories are physically and/or structurally configured in accordance with the computer program instructions.

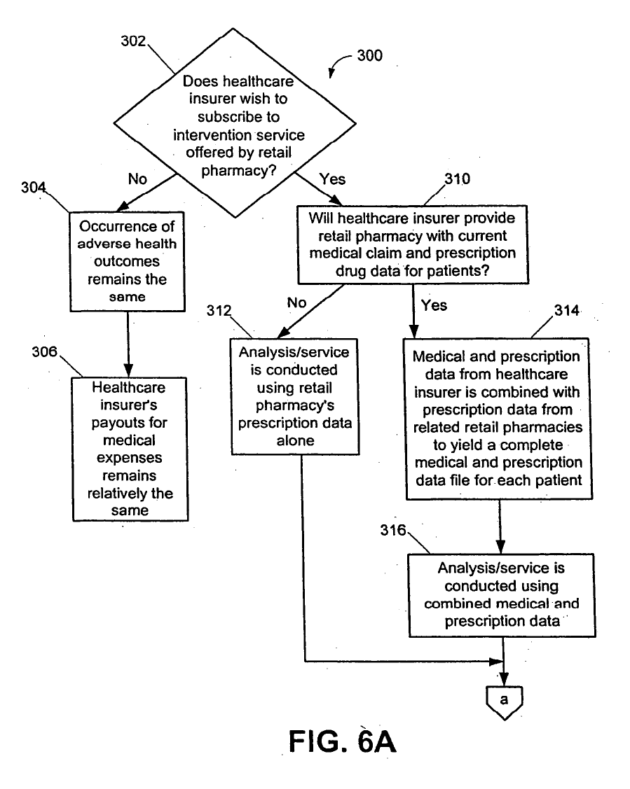

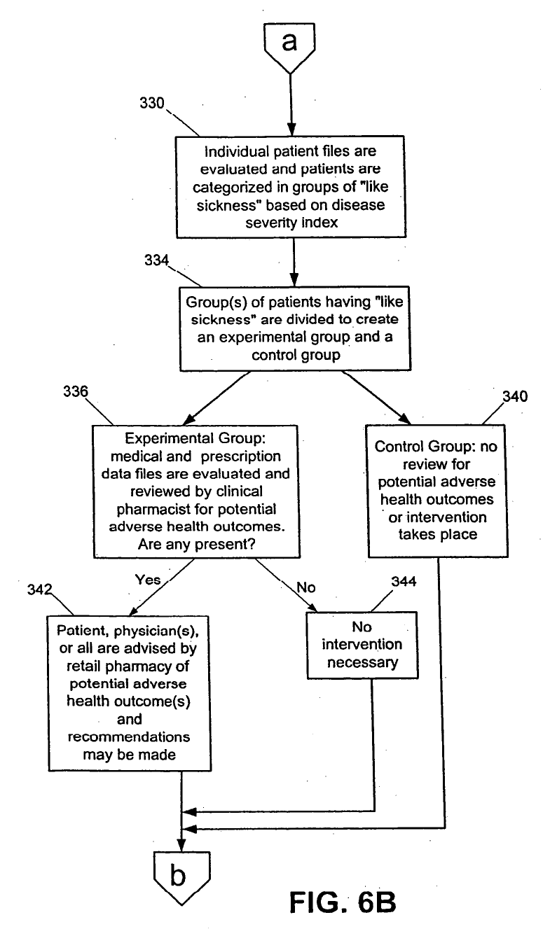

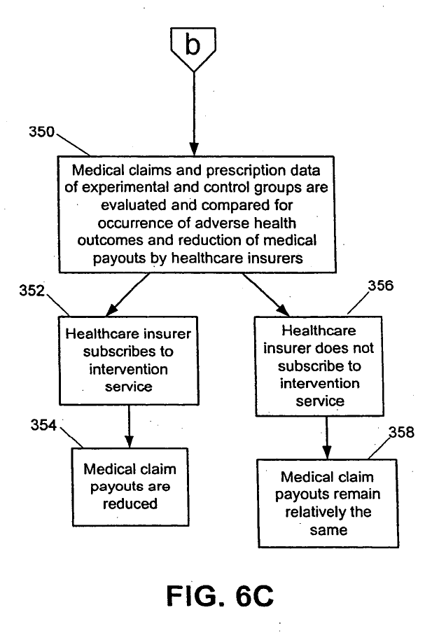

FIGS. 6A, 6B, and 6C are three parts of a flow chart 300 describing some of the steps used in analyzing patients' prescription/medical claim data and intervening where necessary to prevent adverse health outcomes. Further illustrated by flow chart 300 are steps used to facilitate selling of an intervention service including the additional service of determining the impact of the intervention by comparing the healthcare costs of the intervention group with that of the control group. Some of the steps shown in the flowchart 300 may be stored in the memory of the controllers 100 and 200.

Prior to an analysis of any individual's prescription/medical claim data for adverse drug-drug and drug-disease combinations, the retail pharmacy first explains the intervention service and the advantages thereof to the healthcare insurer. Specifically, the retail pharmacy may propose that subscribing to the intervention service will reduce the occurrence of adverse health outcomes in patients covered by the healthcare insurer and will, therefore, reduce the overall healthcare costs being paid out by the healthcare insurer. In explaining the service to the healthcare provider, the retail pharmacy will likely explain the fee associated with such a service. The healthcare provider may require additional, credible data supporting the cost/savings analysis of such a service. Such a cost/savings report that details the impact of the intervention service, i.e., contacting doctors, patients, or both regarding potential adverse health outcomes, may be generated using comparison methodology based on disease severity index scores, as explained in detail below. This type of report demonstrates the return on investment associated with the intervention service, and provides motivation for subscribing to such a service.

Should the healthcare insurer wish to subscribe to the intervention service being offered by the retail pharmacy, it would be to the healthcare provider's advantage to provide the retail pharmacy with current medical claim and prescription data for patients covered by the healthcare insurer. Referring to FIG. 6A, the flowchart 300 may begin at block 302 when a retail pharmacy approaches a healthcare insurer and inquires into whether the healthcare insurer wishes to subscribe to the intervention service. If it is determined at block 302 that the healthcare insurer does not wish to subscribe to the service offered by the retail pharmacy, then the occurrence of adverse health outcomes in patients covered by the healthcare insurer will remain relatively the same, as shown at block 304. In turn, the payouts for medical expenses will remain relatively the same (block 306).

Alternatively, the healthcare insurer may wish to subscribe temporarily or permanently to the intervention service. In this case, as illustrated in block 310, the retail pharmacy will request that the healthcare insurer provide the pharmacy with all current medical claim data and known prescription data for each individual patient covered by the healthcare insurer, or at least of those patients to whom the healthcare insurer wishes to apply the intervention service. Where the healthcare insurer declines to provide such data to the retail pharmacy, the analysis and intervention service will proceed based on prescription data alone. Prescription data for each individual may be obtained from multiple, related stores 20 of the retail pharmacy (block 312), assuming the customer/patient has previously obtained prescription drugs from the pharmacy. Such data may be transmitted through the store servers 36 and the network 32 to the network computer 30. (See FIG. 1.) Otherwise, the analysis will proceed based on all future prescriptions. As shown in block 314, where the healthcare insurer provides the retail pharmacy with the requested data, a complete medical and prescription file is created for each patient based on the medical and prescription data supplied by the healthcare insurer combined with any additional prescription data accessible from the related retail pharmacy stores 20. Medical and prescription data from the healthcare insurer's computer 34 may be transmitted through the network 32 to the network computer 30, while the prescription data may be transmitted from the store servers 20 across the same network 32. (See FIG. 1.) The healthcare insurer may update the medical claim data in a variety of ways. For example, the healthcare insurer may provide the updates periodically, in real time, or in near-real time. Individual patient files may be stored on the stores servers 36, on the network computer 30, and may be readily accessible via the healthcare insurer's computer 34.

Patient files may be created for each patient upon receipt of the medical claim data from the healthcare insurer. Alternatively, where patients have previously had prescriptions filled at the retail pharmacy, individual patient files may already exist. In this case, the patient files could simply be supplemented with any additional medical/prescription data obtained from the healthcare insurers. Individual patients may have unique customer ID numbers that may be stored in the retail pharmacy's patient account database 102 that is operatively connected to the network computer 30 (See FIG. 4.) The unique customer ID may be associated with a large amount of personal information relating to the patient/customer. For example, the patient account database 102 may store information including the patient's name, address, electronic address, telephone number, birth date, social security number, insurance providers, etc. Also associated with the customer ID may be the patient's electronic file containing the medical and prescription data as collected from the healthcare insurer and from the various retail pharmacies. The patient's personal information, including medical and prescription data, may be protected using appropriate security methods, linked to the patient's unique customer ID, and stored in the customer account database 102 using methods well known to those of ordinary skill in the art.

Store employees or pharmacists may access a patient's file on the customer account database 102 from the POS terminal 210. The store employee or pharmacist may then enter the new prescription data into the patient's file. This information entered at the POS terminal 210 may be transmitted through the store server 36 and the network 32 to the network computer 30.

Once the network computer 30 is accessed for the patient's file by the store 20, the store server 36 may temporarily store the patient's file so that retrieval of information or updates to the file in the near future may be performed locally, thus reducing network traffic. If the patient's file is not located in the patient account database 102, then the store employee may be prompted to create a new patient file, especially where the patient is covered by a healthcare insurer that subscribes to the intervention service.

Still referring to the flow chart 300, and in relation to box 314, the store server 36 may accumulate prescription data for multiple transactions at the stores 20 and transfer that data via the network 32 to the network computer 30. The transfer of the prescription data may occur after each transaction, or it may occur periodically, such as hourly, nightly, weekly, monthly, etc. The network computer 30 may update the patient account database 102 with the latest prescription data from the stores 20. The pharmacy's network computer 30 may also periodically transfer prescription data to healthcare insurer 34 via the network 32 or any other acceptable link. Likewise, medical claim updates can be transferred from the healthcare insurers 34 to the network computer 30 over the network 32 or any other link. As indicated by box 316, analysis of each individual's file proceeds based on the combined medical and prescription data as obtained from both the healthcare insurer and from various related retail pharmacies.

The flow chart 300 continues in FIG. 6B where patients' files are evaluated for degrees of sickness (block 330). Specifically, the patients' medical claim data and prescription data are analyzed. The patients are then categorized based on the disease severity index. The disease severity index can be described as a continuum of sickness on which patients can be placed or categorized. A patient's disease severity index score may be based on one or a combination of a number of factors related to the patient's prescription regimen, including for example: number of medications, therapeutic classes of medications, number of pharmacies, number of doctors, inferred disease(s), actual disease(s), age and gender of patient, and laboratory data if provided.

While not necessarily required, the assignment of disease severity index scores may be automated. Specifically, a system comprising software specially designed for such analysis may be used to assign patients their appropriate disease severity index score. The software may be accessible on the network computer 30 via the network 32. Hence, the healthcare insurer 34, the stores 20, and other authorized users may have access to the software. Accordingly, the software may be employed, and patients may be categorized by a pharmacist or other individuals associated with the retail pharmacy. Alternatively, a prescription drug manager 50 may be using the software and assigning patients' disease severity index scores. (See FIG. 2.) The prescription drug manager 50 may be an outside vendor hired by the retail pharmacy and may have access to the network computer 30 via the network 32. Whatever the case may be, the medical and prescription data for each patient covered by the healthcare insurer is evaluated, various inquires are made (as described above), and each patient is assigned a disease severity score or range.

As indicated in box 334, groups of patients having “like sickness” (based on the disease severity index scores) are divided to create intervention or experimental groups (box 336) and a control or comparison groups (box 340). The number of patients in each group may be the same. Groups of “like sickness” based on the disease severity index may include groups of individuals, all having the same disease severity index score or range. In this case, the corresponding experimental and control group would simply be two groups, all of the individuals within both groups having the same disease severity index score. Alternatively, where the initial group of “like sickness” patients includes patients of varying disease severity index scores, the disease severity index scores within the experimental and control groups may vary, so long as the ratios of the disease severity scores between the experimental and control groups are equivalent. For example, an initial “like sickness” group wherein 50% of the patients have a high disease severity index score and 50% have a low disease severity index score requires a division into experimental and control groups having the same ratios. Stated differently, it would be improper for the initial group to be divided such that all the individuals in the experimental group have a high disease severity index score, while all the individuals in the control group have a low disease severity index score. Instead, the patients of the experimental and control groups should consist of approximately 50% with a high disease severity score and approximately 50% with a low disease severity score. In this manner, the differences between the two groups are minimized and, thus, the two groups can be accurately compared with each other. In other words, any significant differences in occurrences of adverse health outcomes and healthcare costs observed between the two groups may be attributed to the conditions applied to the experimental group, rather than a difference in degrees of sicknesses between the two groups. Such methodology is commonly referred to as comparison methodology.

Continuing down the flowchart 300, as indicated by box 336, the medical and prescription data files of the patients within the experimental group are subjected to further analysis. Specifically, each patient's file is evaluated by a clinical pharmacist for potential adverse health outcomes resulting from, for example, consumption of hazardous or ill-advised combinations of drugs, in light of the particular drugs, or in light of the patient's various, simultaneous illnesses. Adverse health outcomes may include, for example, toxicity. Alternatively, drug-drug interactions may result in decreased efficacy of one or all drugs consumed. Further, one drug taken to treat a particular illness may be detrimental to recovery where a concurrent, different illness is concerned. Because physicians may not be aware of all the prescription drugs individual patients are taking, these types of dangerous combinations are not automatically or easily avoided by the prescribing doctors.

As with the assignment of the disease severity index scores, evaluation of patients' files for adverse health outcomes may be assisted by computer software. For example, upon command, analysis of a patient's medical and prescription data may be performed and a report may be automatically generated that indicates obvious, potential adverse health outcomes. As described above, such software may be accessible on the network computer 30 via the network 32. Hence, both the healthcare insurer 34 and the stores 20 may have access to the software. Accordingly, evaluation of patients' files for adverse health outcomes may be by clinical pharmacist at one of the retail pharmacy stores 20 or other individuals authorized by the retail pharmacy.

Alternatively, the individual patient files may be evaluated for potential adverse health outcomes by a prescription drug manager 50; (See FIG. 2.) The prescription drug manager 50 may be an outside vendor hired by the retail pharmacy and may have access to the network computer 30 via the network 32. If a separate prescription drug manager 50 is used by the retail pharmacy, the retailer may transfer prescription data from either the store(s) 20 or the network computer 30 to the prescription drug manager 50 via the network 32. Regardless of which arrangement the pharmacy uses, a clinical pharmacist may evaluate either an automatically generated report or the raw medical and prescription data of each patient for adverse health outcomes resulting from drug-drug and/or drug-disease interactions. Where the pharmacy utilizes a separate prescription drug manager 50, the updated patient file may be transferred via the network 32 to the network patient's customer account database 102. The patient's updated file may also be transferred via the network 32 to the store server 36.

As indicated in box 342, intervention of a patient's treatment occurs when adverse health outcome(s) are identified or forecasted by the clinical pharmacist responsible for reviewing each patient's medical/prescription data. Specifically, the retail pharmacy or clinical pharmacist contacts the physician(s), the patient, or both in an effort to inform and prevent the identified drug-drug or drug-disease interactions that may result in adverse health outcomes. In doing so, the retail pharmacy or an entity associated with the pharmacy will make the parties aware of the potential for adverse health outcomes, may inform the physicians as to various other drugs taken by the patient, and may also recommend different or additional treatments. In addition, the pharmacy may make recommendations regarding compliance with instructions for taking particular medications. Such communication between the retail pharmacy and the doctor and/or patient may take place via telephone, mail, electronic mail, etc., or any combination thereof. Further, the retail pharmacy, or a system utilized by the pharmacy, may automatically generate such communications.

Such an intervention may take place initially, i.e., when healthcare insurers subscribe to the service and the relevant medical/prescription data becomes available to the pharmacy. Thereafter, this service can be provided at random or at calculated intervals. Alternatively, the service can be provided each time a patient of the healthcare insurer has a prescription filled at the retail pharmacy. As described in reference to FIG. 3, a network 10 is provided wherein a customer/patient device 80 is linked to the network 32, thereby enabling a patient/customer to order or submit prescriptions with the retail pharmacy web site using the customer/patient device 80. Access to the retail pharmacy web site may be made available via the Internet, where a customer may enter his/her unique customer ID or other personal information to access his/her file. The customer may access the internet using the customer device, 80 from FIG. 3, and the pharmacy's web site may be stored on the network computer 30 or any other acceptable server that is connected to the network 32. This allows the customer to submit or order prescriptions from the retailer without having to physically visit the pharmacy. In addition, this allows the patient to update his/her pharmacist with regard to additional, previously undisclosed medical or prescription data. Alternatively, the patient may be given a mail-in account update form so that the patient may complete the mail-in form and send it to the retailer to perform an update of his/her file. Upon receipt by the retail pharmacy of the patient's prescription or other information, the new prescription data or other information may be entered into the patient's file, and the analysis for adverse outcomes in light of the additional information may be performed.

The store employee or pharmacist may update the patient's file at the POS terminal 210 by entering a minimal amount of information, such as, for example, the patient's name or unique customer ID. The additional prescription or medical information associated with the patient may be stored in the network computer's patient account database 102.

Referring to FIG. 6C, the flow chart 300 continues at block 350 with the evaluation of the post-intervention medical claims and the prescription data of both the experimental group (intervention group) and the control group (comparison group). Specifically, the prescription data available to the retail pharmacy and the medical claim data provided periodically by the healthcare insurer are evaluated regarding the occurrence of adverse health outcomes and costs of the same to the healthcare insurers. Specifically, clinical pharmacists or other individuals, on behalf of the retail pharmacy, may evaluate the prescription data of individual patients to determine whether the intervention had any impact on a patient's drug regimen in general, or operated to avoid any potential adverse health outcomes previously predicted by the pharmacists. Clinical markers, including hospitalizations and emergency room visits, are often indicative of adverse health outcomes and may be considered when measuring impact of the intervention. Overall, the occurrence of adverse health outcomes and cost to health insurance providers may be evaluated and compared between the experimental (intervention) and control (comparison) groups to determine the overall impact of providing the intervention. The results may then be detailed in a cost/savings report generated by the retail pharmacy. Decreased medical expenses observed with regard to patients of the experimental group may be the result of a reduction in the numbers of medications taken or less expensive medications, along with a decrease in the numbers of hospital and/or physician visits.

As explained above, any differences in adverse health outcomes and healthcare costs observed between the experimental and control groups are likely attributable to the intervention, as the differences between the two groups are minimized by the degrees of sickness and the potential for adverse health outcomes between the groups being essentially equal. Stated differently, accurate and credible data on the impact of intervention can be obtained using comparison methodology based on the disease severity index. The same can then be reported to the healthcare insurers. Such data may be relied upon by the healthcare insurers in deciding whether to subscribe permanently to the intervention service.

Upon receipt of data describing the favorable impact of the intervention service, the healthcare insurer may decide to subscribe to the intervention service (box 352), in which case the healthcare insurer's medical payouts may decrease (box 354). Alternatively, the healthcare insurer may altogether abandon the service (box 356), in which case the healthcare insurer's medical payouts should remain relatively the same (box 358).

Although the intervention service and various methods of measuring the impact thereof, as described herein, are implemented in software, it may be implemented in hardware, firmware, etc., and may be implemented by any other processor associated with the store and other facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

The invention has been described in terms of several preferred embodiments. It will be appreciated that the invention may otherwise be embodied without departing from the fair scope of the invention.

1. A method of medical intervention comprising:
receiving data relating to one or more prescriptions for a person;
evaluating the prescription data for an adverse health outcome; and
intervening in a medical treatment of the person in response to a detected adverse health outcome based on the prescription data.

2. The method of claim 1, further comprising:
receiving data relating to medical insurance for the person;
evaluating the medical insurance data and the prescription data for an adverse health outcome; and
intervening in the medical treatment of the person in response to a detected adverse health outcome based on the prescription data and the medical insurance data.

3. The method of claim 1, wherein the adverse health outcome comprises a potential adverse health outcome based on the prescription data.

4. The method of claim 1, wherein the adverse health outcome comprises an identified adverse health outcome based on the prescription data.

5. The method of claim 1, wherein the adverse health outcome comprises one or more of the following: a toxicity outcome or a decreased efficacy outcome.

6. The method of claim 1, wherein intervening in the medical treatment of the person comprises preventing a drug interaction, wherein the drug interaction potentially causes the detected adverse health outcome.

7. The method of claim 6, wherein the drug interaction comprises one or more of the following: an interaction between two or more prescriptions for the person or an interaction between one or more prescription for the person and a disease of the person.

8. The method of claim 1, wherein intervening in the medical treatment of the person comprises one or more of the following: communicating the detected adverse health outcome to the person, communicating the detected adverse health outcome to a physician for the person, communicating one or more of the prescriptions for the person, providing an alternative medical treatment, providing an additional medical treatment, or providing medical instructions.

9. The method of claim 1, wherein the person comprises one of a plurality of persons, the method further comprising:
receiving medical data for each of the plurality of persons;
creating a disease severity index for each of the plurality of persons based on the medical data, wherein the disease severity index represents a degree of sickness of the person;
creating a first group of persons from the plurality of persons based on the disease severity indexes;
creating a second group of persons from the plurality of persons based on the disease severity indexes;
evaluating the medical data for an adverse health outcome for each of the persons in the first group;
intervening in a medical treatment of a person in the first group in response to a detected adverse health outcome based on the medical data;
receiving post-intervention medical data for each of the plurality of persons in the first and second groups; and
evaluating the post-intervention medical data.

10. The method of claim 9, wherein the first group and the second group comprise an equal number of persons.

11. The method of claim 9, wherein the disease severity index of persons in the first group and the second group are equivalent.

12. The method of claim 9, wherein the range of disease severity indexes of persons in the first group and the second group are equivalent.

13. The method of claim 9, wherein a ratio of disease severity indexes in the first group is equivalent to a ratio of disease severity indexes in the second group.

14. The method of claim 9, wherein the disease severity index is based on one or more of the following: a prescription, a medical insurance claim, a quantity of medications, a medication classification, a quantity of pharmacies, a quantity of doctors, an inferred disease, an actual disease, age, gender or laboratory results.

15. The method of claim 9, wherein the post-intervention medical data comprises one or more of the following: prescription data or medical insurance data.

16. The method of claim 9, wherein evaluating the post-intervention medical data comprises measuring an impact of the intervention on the medical treatment of the person.

17. The method of claim 9, wherein evaluating the post-intervention medical data comprises:
determining the occurrences of adverse health outcomes in the first and second groups;
determining a cost associated with the adverse health outcomes in the first and second groups;
comparing the occurrences of adverse health outcomes for the first group with the occurrences of the adverse health outcomes for the second group; and
comparing the cost associated with the adverse health outcome of the first group with the cost associated with the adverse health outcomes of the second group.

18. The method of claim 9, further comprising receiving a subscription request based on the evaluation of the post-intervention medical data.

19. A method of stratifying intervention groups and comparison groups comprising:
receiving medical data for each of a plurality of persons;
creating a disease severity index for each of the plurality of persons based on the medical data, wherein the disease severity index represents a degree of sickness of the person;
creating a first group of persons from the plurality of persons based on the disease severity indexes;
creating a second group of persons from the plurality of persons based on the disease severity indexes;
evaluating the medical data for an adverse health outcome for each of the persons in the first group;
intervening in a medical treatment of a person in the first group in response to a detected adverse health outcome based on the medical data;
receiving post-intervention medical data for each of the plurality of persons in the first and second groups; and
comparing the post-intervention medical data of the first group with the post-intervention data of the second group.

20. The method of claim 19, wherein receiving medical data comprises receiving medical insurance data from a medical insurer, the medical insurance data relating to medical insurance claims by a person.

21. The method of claim 19, wherein receiving medical data comprises receiving prescription data from a pharmacy, the prescription data relating to a prescription for the person.

22. The method of claim 19, wherein receiving medical data comprises receiving medical data from the person.

23. The method of claim 19, wherein the first group and the second group comprise an equal number of persons.

24. The method of claim 19, wherein the disease severity index of persons in the first group and the second group are equivalent.

25. The method of claim 19, wherein the range of disease severity indexes of persons in the first group and the second group are equivalent.

26. The method of claim 19, wherein a ratio of disease severity indexes in the first group is equivalent to a ratio of disease severity indexes in the second group.

27. The method of claim 19, wherein the disease severity index is based on one or more of the following: a prescription, a medical insurance claim, a quantity of medications, a medication classification, a quantity of pharmacies, a quantity of doctors, an inferred disease, an actual disease, age, gender or laboratory results.

28. The method of claim 19, wherein the post-intervention medical data comprises one or more of the following: prescription data or medical insurance data.

29. The method of claim 19, further comprising measuring an impact of the intervention on the medical treatment of the person based on the post-intervention medical data.

30. The method of claim 19, wherein'the post intervention medical data comprises one or more occurrences of adverse health outcomes and a cost associated with each adverse health outcome, wherein comparing the post-intervention medical data of the first group with the post-intervention data of the second group comprises:
comparing the occurrences of adverse health outcomes for the first group with the occurrences of the adverse health outcomes for the second group; and
comparing the cost associated with the adverse health outcome of the first group with the cost associated with the adverse health outcomes of the second group.

31. The method of claim 19, further comprising receiving a subscription request based on the comparison of the post-intervention medical data.

32. A method of intervening in a medical treatment comprising:
receiving prescription data relating to one or more prescriptions for a person;
receiving medical insurance data relating one or more medical insurance claims for the person;
evaluating the prescription data and the medical insurance data for an adverse health outcome; and
intervening in a medical treatment of the person in response to a detected adverse health outcome based on the prescription data and the medical insurance data.

33. The method of claim 32, wherein receiving the medical insurance data comprises receiving the medical insurance data from one or more of the following: a medical insurance provider, a physician of the person, or the person.

34. The method of claim 32, wherein receiving the prescription data comprises receiving the prescription data from one or more of the following: a pharmacy, a medical insurance provider, a physician of the person, or the person.

35. The method of claim 32, wherein intervening in the medical treatment of the person comprises preventing a drug interaction, wherein the drug interaction potentially causes the detected adverse health outcome.

36. The method of claim 32, wherein intervening in the medical treatment of the person comprises one or more of the following: communicating the detected adverse health outcome to the person, communicating the detected adverse health outcome to a physician for the person, communicating one or more of the prescriptions for the person, providing an alternative medical treatment, providing an additional medical treatment, or providing medical instructions.

37. A medical intervention system comprising:
a network;
a server operatively coupled to the network, the server including a database to store medical information;
a controller operatively coupled to the network, the controller including a processor and a memory operatively coupled to the processor,
the controller being programmed to receive the medical information from the server;
the controller being programmed to evaluate the medical information for an adverse health outcome;
the controller being programmed to intervene in a medical treatment of a person in response to a detected adverse health outcome based on the medical information.

38. The system of claim 37, wherein the medical information comprises one or more of the following: prescription information or medical insurance information.

39. The system of claim 37, further comprising a pharmacy server operatively coupled to the network, the pharmacy server comprising the controller.

40. The system of claim 37, further comprising:
wherein the server comprises a medical insurance server including a database to store information related to one or more medical insurance claims;
wherein the controller is programmed to receive the medical insurance information from the medical insurance server;
wherein the controller is programmed to evaluate the medical insurance information for an adverse health outcome;
wherein the controller is programmed to intervene in the medical treatment of the person in response to a detected adverse health outcome based on the medical insurance information.

41. The system of claim 37,
wherein the server comprises a pharmacy server including a database to store information related to one or more prescriptions;
wherein the controller is programmed to receive the prescription information from the pharmacy server;
wherein the controller is programmed to evaluate the prescription information from the pharmacy server for an adverse health outcome;
wherein the controller is programmed to intervene in the medical treatment of the person in response to a detected adverse health outcome based on the prescription information.

42. The system of claim 37, further comprising:
a data input device operatively coupled to the network;
wherein the controller is programmed to receive medical information from the data input device;
wherein the controller is programmed to evaluate the medical information from the data input device for an adverse health outcome;
wherein the controller is programmed to intervene in the medical treatment of the person in response to a detected adverse health outcome based on the prescription information from the pharmacy server and the medical information from the input device.

43. The system of claim 37,
wherein the medical information comprises medical information relating to a plurality of persons;
wherein the controller is programmed to create a disease severity index for each of the plurality of persons based on the medical information, wherein the disease severity index represents a degree of sickness of the person;
wherein the controller is programmed to create a first group of persons from the plurality of persons based on the disease severity indexes, wherein the person comprises one of the plurality of persons in the first group;
wherein the controller is programmed to create a second group of persons from the plurality of persons based on the disease severity indexes;
wherein the controller is programmed to evaluate the medical data for an adverse health outcome for each of the persons in the first group;
wherein the controller is programmed to receive post-intervention medical data for each of the plurality of persons in the first and second groups; and
wherein the controller is programmed to compare the post-intervention medical data of the first group with the post-intervention medical data of the second group.

44. The system of claim 43,
wherein the controller is programmed to provide results of the comparison to a medical insurer;
wherein the controller is programmed to receive a subscription request from the medical insurer based on the results.

45. An article comprising a machine-accessible medium having stored thereon instructions that, when executed by a machine, cause the machine to:
receive medical information;
evaluate the medical information for an adverse health outcome; and
intervene in a medical treatment of a person in response to a detected adverse health outcome based on the medical information.

46. The article of claim 45, wherein the medical information comprises one or more of the following: prescription information or medical insurance information.

47. The article of claim 45 wherein the medical information comprises medical information relating to a plurality of persons, the article having further instructions that, when executed by the machine, cause the machine to:
create a disease severity index for each of the plurality of persons based on the medical information, wherein the disease severity index represents a degree of sickness of the person;
create a first group of persons from the plurality of persons based on the disease severity indexes, wherein the person comprises one of the plurality of persons in the first group;
create a second group of persons from the plurality of persons based on the disease severity indexes;
evaluate the medical data for an adverse health outcome for each of the persons in the first group;
receive post-intervention medical data for each of the plurality of persons in the first and second groups; and
compare the post-intervention medical data of the first group with the post-intervention medical data of the second group.

48. The article of claim 47 having further instructions that, when executed by the machine, cause the machine to:
provide results of the comparison to a medical insurer; and
receive a subscription request from the medical insurer based on the results.
